(19) United States
(12) Patent Application Publication
(10) Pub. No.: US 2022/0326696 A1
(43) Pub. Date: Oct. 13, 2022

(54) METHOD FOR OPTIMIZING A MODULAR SYSTEM FOR TECHNICAL FUNCTIONAL UNITS OF A PROCESS ENGINEERING PLANT

(71) Applicant: SAMSON AKTIENGESELLSCHAFT, Frankfurt (DE)

(72) Inventors: Andreas Widl, Muenchen (DE); Philipp Friedrichs, Cologne (DE)

(73) Assignee: SAMSON AKTIENGESELLSCHAFT, Frankfurt (DE)

(21) Appl. No.: 17/635,321

(22) PCT Filed: Aug. 13, 2020
(86) PCT No.: PCT/EP2020/072791

§ 371 Date: Feb. 14, 2022

(30) Foreign Application Priority Data
Aug. 14, 2019 (DE) 10 2019 121 913.2

(51) Int. Cl. G05B 19/418

(52) U.S. Cl. CPC G05B 19/41885; G05B 19/41845; G05B 2219/32352

(57) ABSTRACT

In a method for optimizing a modular system for technical functional units of a process engineering plant, a modular system is provided having components for configuring technical functional units. The modular system can be projected in a simulation environment such that each component can be represented based on its physical properties as a virtual component with corresponding parameters in the simulation environment. Parameters of the virtual components are varied in the simulation environment to determine a modified configuration of at least one technical functional unit using at least one of the virtual components with at least one varied parameter. The operation of the technical functional unit(s) is simulated with the modified configuration. A set of virtual components is determined from the virtual components with varied parameters based on results of the simulation. One or more components of the modular system are adapted based on the determined set of virtual components.

### CROSS REFERENCE TO RELATED APPLICATIONS

This patent application is a U.S. National Stage Application of PCT/EP2020/072791, filed Aug. 13, 2020, which claims priority to German Patent Application No. 10 2019 121 913.2, filed Aug. 14, 2019, each of which is incorporated herein by reference in its entirety.

### BACKGROUND

### Field

The present disclosure relates to a method for optimizing a modular system for technical functional units of a process engineering plant. In addition, the present disclosure relates to a computer-readable storage medium having commands stored thereon for setting up a computing device for executing the method for optimizing the modular system. The present disclosure additionally relates to a computing device which is designed for carrying out the method according to the disclosure and a corresponding system.

### Related Art

The use of modular systems for configuring technical functional units of process engineering plants is well-known. Here, a modular system typically comprises a multiplicity of complex technical components which can be used to configure a desired technical functional unit. Typically, individual parameters of the components can be adjusted in a predefined range in order to realize diverse technical functional units with desired physical properties. The components of the modular system can be prefabricated and can be used in a versatile manner. By means of the modular principle, costly novel developments of functional units can therefore be reduced. In the event of changes to the requirements on technical functional units, admittedly, an existing variability of the parameters of the components of the modular system can be used in order to adjust a technical functional unit to the changed requirements. Furthermore, further components of the modular system can be called upon in order to realize required physical properties of the technical functional unit. However, determining suitable possible solutions may be difficult. In addition, the possible solutions of such modular systems are limited to the variability of the parameters of the fixed components. In many cases, solutions can only be provided, which although they substantially fulfill the predetermined requirements, they in no way represent optimal configurations of the technical functional unit, as requirements required for that may be missing in the modular system.

It has on occasion been suggested to simulate functional units in a simulation environment in order to determine an optimum design. For example, it is suggested in WO 2016/141998 A1 to provide a digital representation of a physical entity, in order to simulate the physical entity in combination with further physical entities. A virtual test bed for field devices of an automation device is disclosed in EP 3 082 001 A1. To extend the automation device by one field device, initially a corresponding virtual field device is connected to the automation device virtually. Furthermore, a suitable control module is coupled to the automation device virtually in order to determine the load of the virtually connected components. If a predetermined load limit is not exceeded, both the control module and the field device can be approved for real operation. Although the simulation of virtual representations simplifies the discovery of suitable physical components for real operation, the scope of the solution remains limited to properties and the variability of available physical components.

A simulation of the operation of a plurality of nodes of a process control system, which are connected to one another and can be configured by means of configurations in a database, is disclosed in DE 103 48 402 B4. Individual nodes of the process control system can be marked for simulation purposes, as a result of which, copies of assigned modules and corresponding configurations are retrieved from the configuration database. The copies of the modules are stored in a simulation computer and automatically converted into simulation modules, in order to carry out the simulation. This solution enables a simplified simulation on the basis of stored configurations. However, the solutions discovered here are limited to the available variability of the physical components.

WO 2018/001650 A1 covers the configuration of production processes for sub-products of an assembled product. On the basis of a process model, data about production steps are read out in order to determine corresponding production modules. Instructions from the respective production steps are transmitted to associated production modules by means of signal connections specifically provided for that. The process model is represented by a graph, wherein nodes of the graph describe respective process steps and slopes of the graph describe the dependencies between the production steps. However, the approach does not go beyond the configuration of the production process. Accordingly, provision is not made for an optimization of available components for a modular system.

In WO 2016/179455 A1, an optimization of the product design on the basis of determined data of a product life cycle is disclosed. To this end, a multiplicity of product life cycle models is set up, which product life cycle models are assigned to corresponding stages in the life cycle of the product. At each of these stages, data records are collected via a web interface and stored in a database, in order to update the respective product life cycle models. The updated models are called upon to optimize the product design. Even if the product design should be adaptable on the basis of determined product life cycle data, this approach can only be applied to an optimization of the resultant complete product. An optimization of a composition of an underlying modular system is not provided here.

### BRIEF DESCRIPTION OF THE DRAWINGS/FIGURES

The accompanying drawings, which are incorporated herein and form a part of the specification, illustrate the embodiments of the present disclosure and, together with the description, further serve to explain the principles of the embodiments and to enable a person skilled in the pertinent art to make and use the embodiments.

FIG. 1 shows virtual components according to exemplary embodiments of the present disclosure.

FIG. 2 shows a schematic view of a variation of parameters according to exemplary embodiments of the present disclosure.

FIG. 3 shows a schematic view of an environment for optimizing a modular system according to exemplary embodiments of the present disclosure.

FIG. 4 is a flowchart of a method according to an exemplary embodiment of the present disclosure.

The exemplary embodiments of the present disclosure will be described with reference to the accompanying drawings. Elements, features and components that are identical, functionally identical and have the same effect are — insofar as is not stated otherwise — respectively provided with the same reference character.

### DETAILED DESCRIPTION

In the following description, numerous specific details are set forth in order to provide a thorough understanding of the embodiments of the present disclosure. However, it will be apparent to those skilled in the art that the embodiments, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring embodiments of the disclosure. The connections shown in the figures between functional units or other elements can also be implemented as indirect connections, wherein a connection can be wireless or wired. Functional units can be implemented as hardware, software or a combination of hardware and software.

An object of the present disclosure is to improve the disadvantages of the conventional solutions, including to specify a method for optimizing a modular system for technical functional units of a process engineering plant, using which real components of an existing modular system can be adapted to changing and growing requirements in an automated and dynamic manner, so that an optimized modular system can be provided.

According to the disclosure, a method for optimizing a modular system for technical functional units of a process engineering plant is specified, which comprises providing a modular system having a multiplicity of components for configuring technical functional units of a process engineering plant, wherein the modular system can be represented in a simulation environment in such a manner that each component from the multiplicity of components of the modular system can be represented on the basis of its physical properties as a virtual component with corresponding parameters in the simulation environment, varying parameters of the virtual components in the simulation environment, in order to determine at least one changed configuration of at least one technical functional unit using at least one of the virtual components with at least one varied parameter, and simulating the operation of the at least one technical functional unit of the process engineering plant with the at least one changed configuration, determining a set of virtual components from the virtual components with varied parameters based on results of the simulation, and adapting one or more components of the modular system on the basis of the determined set of virtual components.

The simulation environment simulates virtual representations of the real components of the modular system for specific configurations of functional units. Here, various configurations of the technical functional unit are determined and simulated for variations of parameters of the virtual components. A suitable and optimum configuration of the technical functional unit on the basis of the simulated virtual components can finally be determined from the simulation results and the virtual components used here can be determined here with their varied parameters. A simulation-based optimum realization of a technical functional unit made up of available components of a modular system by means of simulation is described for a field device station in DE 10 2018 013 342 A1. Here, a process engineering plant is represented with a technical functional unit to be designed in the simulation environment. This implies that a real process engineering plant with real technical functional units is digitally imaged onto a virtual plane, as a result of which a digital representation, which can likewise be termed a digital twin, can be provided to the process engineering plant and the technical functional units in the simulation environment. The simulation environment can simulate the operation of the digital representation of the process engineering plant using the digital representation of the technical functional units. The simulation environment can simulate the operation of the digital representation of the process engineering plant in such a manner that the simulated behaviour (or the simulated operating variables) of the digital representation of the process engineering plant corresponds to a behaviour (or operating variables) of the real process engineering plant within the scope of fault tolerance, so that results of the simulation of the digital representation of the process engineering plant in the simulation environment allow direct conclusions about the operation of the real process engineering plant.

According to the disclosure, it is further provided that the digital representation of the functional units is built up from virtual components, which is specified by the digital representation of the modular system. The digital representation of the functional unit can therefore be assembled in the simulation environment from the virtual components of the modular system. In the simulation environment, modules can be provided for the individual components, which modules simulate the behaviour of at least a section of the represented components of the modular system in a physically-based manner. The technical functional units assembled from the virtual components and simulated are not limited here to a single device, for example a field device, but rather allow the simulation of a multiplicity of technical functional units.

A simulation environment for process engineering plants can be implemented in the form of software, hardware or as a combination thereof. For example a simulation logic, which provides the simulation environment, may be specified on one or more computing devices. The simulation logic may be realized at least to some extent as software or as specialized hardware. The simulation logic can further be distributed over the computing devices. For example, parts of the simulation logic may be realized in a decentralized or distributed computing environment, which can likewise be termed a cloud.

According to the disclosure, results from simulations with variations of the parameters of the virtual components can be called upon in order to determine optimum configurations of the technical functional units, even with components which are not yet available in the real modular system. The simulation environment consults the totality of simulation results in order to identify components which are not yet available in the real modular system, but which were used for an optimum configuration of at least one technical functional unit. Here, both optimum combinations of the components, for example on the basis of their number or complexity, and the necessity of the components for realizing certain configurations of technical functional units can be taken into account. To this end, metrics-based optimization algorithms or search algorithms can for example be used for discovering local or global optima. Alternatively or additionally, machine learning methods can be used. On this basis, an optimum configuration of the modular system can be determined from the existing components of the modular system and the varied components that are determined. According to the disclosure, the individual components of the modular system itself are therefore designed in order to determine an optimum composition of the modular system.

The changed configurations of technical functional units that are used as a simulation basis in the simulation environment can here be adapted to changed or novel circumstances, which may result from real operation or simulated operation of technical functional units, which are already completely configured and which can for example be determined on the basis of diagnostic results from real operation or which may be caused by process changes or technological changes, for example due to climatic changes or changing environmental conditions, temperature, atmosphere, to which the functional units may be exposed in the process engineering plant, due to technical progress or a changing technology, such as for example standardized wireless data transmission, a lack of external power supply, and the like. The changed combination of the modular system that is determined is therefore itself automatically and dynamically adapted to the changed and novel circumstances. The composition of the modular system can therefore constantly be kept up-to-date fully automatically and dynamically, wherein different influential factors can be taken into account. If required, the production of the modular system can entirely be converted to the novel determined combination of the components.

According to an advantageous embodiment of the disclosure, the method further comprises adding the set of virtual components determined to the simulation environment. Starting from an initial set of virtual components, the simulation environment can therefore constantly be extended by varied virtual components, which have already been discovered and which were determined in a preceding simulation result as parts of an optimum composition of the modular system. It is not important here whether account was taken of these discovered virtual components in the real production of the modular system, as their suitability could be determined in at least one simulation cycle. All virtual components (the initial ones and those subsequently added) may be stored in a database or in a suitable storage structure and retrieved directly in future simulation steps, in order to simulate novel changed configurations of technical functional units in process engineering plants. As a result, the database of the simulation environment is advantageously expanded. In an exemplary embodiment, in an optimization that is executed in parallel, the database can be cleared of available virtual components in that duplicates or surpluses are removed from the database on the basis of similarity criteria or a usage statistic.

In a further embodiment of the method, one or more attributes are assigned to each virtual component, which describe interactions between the virtual component and one or more of at least one other virtual component, at least one technical functional unit and/or at least one process engineering plant. The physical influential factors, which relate to the individual virtual components are either known or can also result from real operation or from a desired configuration of the technical functional unit and/or the process engineering plant. The influential factors can therefore receive a fixed assignment at component level by means of the attributes and can be adapted to changes that arise fully automatically. Each component may define a matrix here, which specifies the relationships of the respective influential variables to one another and their connections. In an exemplary embodiment, the matrix may specify correlations of the influential variables.

According to an embodiment, the attributes are further linked with at least one of historical diagnostic data of components, technical functional units and/or process engineering plants, real operating data of components, technical functional units and/or process engineering plants, and virtual operating data of simulated virtual components, technical functional units and/or process engineering plants.

In a further embodiment, the attributes are further linked with at least one of manufacturing, assembly and/or commissioning information for at least one corresponding component, technical functional unit and/or process engineering plant.

In an exemplary embodiment, the attributes may have at least one weighting. The weighting may indicate individual virtual components and their importance, so that corresponding important virtual components can preferably be taken into account in the composition of a changed modular system. The weighting can be defined on the basis of production criteria, but also on the basis of strategic considerations or customer-specific information. The individual factors may be represented in a set of weightings. Alternatively or additionally, it may be possible to combine the individual factors by means of a function and thus represent the same as an overall score of the component by means of an individual (overall) weighting.

The attributes and their correlations to one another therefore allow the taking into account of a multiplicity of influential factors at component level, which can be taken into account fully automatically and dynamically in the composition of an optimum replacement of components for the modular system.

Furthermore, according to an exemplary embodiment, the attributes can influence the variation of the parameters. Accordingly, the variation of the parameters takes place on the basis of the attributes and/or a correlation of the attributes. The determination of the variations can therefore directly influence the influential factors which act on the individual components. For example, components may be varied, which have a particularly high weighting and thus should preferably be tested. Furthermore, virtual components can be taken into account, which have suitable physical properties and interactions with further virtual components. Also, it is conceivable that virtual components are taken into account, which are affected by influential factors from real operation, for example fault notifications, or have an effect on changing technological circumstances.

According to an embodiment of the present disclosure, the parameters of the virtual components are varied by a calculation module, which determines at least one variation of a parameter of a virtual component in the simulation environment for a technical functional unit.

In an embodiment, the method comprises training the calculation module with training data based on the attributes and linked information. The calculation module can initially be trained with data, which represent the effects of the influential factors on the individual components and/or which describe the influences of the selection (under variation) of individual virtual components on the realization of an actual configuration of assembly of technical functional units. The calculation mode may be trainable in such a manner that it fully automatically detects relationships and patterns between the virtual components in the simulation environment and the defined influential factors, so that the calculation module can in future decisions select virtual components for variation of their parameters for the totality of the existing influential factors in a targeted fashion in order to simulate desired configurations of technical functional units in the simulation environment.

According to a further embodiment, the determination of the set of virtual components features an application of a search algorithm for discovering an optimized combination of virtual components for configuring at least one technical functional unit of the process engineering plant. The search algorithm may for example be an A* algorithm with an estimation function, in order to discover the set of virtual components in a targeted manner. The A* algorithm is a complete and optimum algorithm which always finds an optimum solution if it exists. It should however be understandable that further search algorithms can be used, for example IDA*, bidirectional search pattern, minimax methods, alpha-beta search and the like.

In a further embodiment, the set of virtual components is determined by a decision core of the calculation module, wherein the decision core is trained with data which specify already configured modular systems for functional units of process engineering plants. The decision core can be trained here in such a manner that it fully automatically detects relationships and patterns in the composition of modular systems. Thus, the decision core can determine sets of virtual components for changing an existing modular system in future decisions by means of an optimum composition of modular systems in a targeted fashion, which optimize the modular system with regards to the influential factors and desired configurations of technical functional units.

In an exemplary embodiment, the calculation module has one or more of a statistical decision core or a support vector machine and the like, or at least one artificial neural network or an analysis core based on a logistic regression, a distance classifier, a polynomial classifier or a cluster method. Furthermore, further machine learning methods may be provided, which can be summarized under the broader term “artificial intelligence”. The calculation module can here have a module for selecting and varying the parameters of the virtual components and a further module for determining the set of virtual components. Both modules may be trainable separately. Furthermore, self-learning modules may be provided, which learn automatically or semi-automatically from simulation and selection steps that have taken place. As a result, the database is automatically enlarged and the system is automatically and dynamically adapted to current developments.

According to a further embodiment, the technical functional unit has at least one field device station, such as a control valve, a pump, a sensor or the like, wherein the process engineering plant may be a chemical plant, a food-processing plant, a power station or the like.

In an exemplary embodiment, the process engineering plant can be represented in the simulation environment on the basis of operation-specific plant features, showing the type of a process medium, process fluid flow, number of field device stations, plant environment or the like.

In a further embodiment, the simulation influences at least one operating variable, such as a control variable, for example temperature, pressure, flow or the like, of the process engineering plant represented.

According to an embodiment, the varied parameters have at least one of a geometric parameter or a power parameter, such as actuator power, pump performance, a flow coefficient or the like.

According to an exemplary embodiment, the method further comprises a repeated variation of parameters, in order to determine at least one further changed configuration of the at least one technical functional unit, and repeated simulation of the operation of the at least one technical functional unit of the process engineering plant with the at least one further changed configuration. The iterative execution of the variation of the parameters and the simulation of the correspondingly designed technical functional unit can be carried out fully automatically and continuously. Furthermore, the interactions can be ended if a quality value or score of the discovered optimized composition of the modular system is no longer exceeded even in the case of repeated simulation. Such a decision can for example be controlled by means of one or more threshold values.

In an embodiment, the simulation environment is provided at least to some extent in a distributed computing environment, which is set up to simulate the operation of a technical functional unit of the process engineering plant for a changed configuration. Various parts of the simulation environment can therefore be parallelized, as a result of which optimum calculation of a multiplicity of variations and simulations for the desired configurations of the technical functional units can be carried out. Furthermore, the utilization of the respective computing systems can be taken into account in the distribution of the tasks of the simulation environment to the individual computing systems of the distributed computing environment.

In an exemplary embodiment, the method further comprises providing the changed modular system for configuring technical functional units of the process engineering plant. Changed modular systems can be provided according to predefined production cycles. Furthermore, the provision may be limited by explicit requirements and by circumstances, for example by evaluation of diagnosis and error logs. Finally, a change of the modular system can also be recommended fully automatically if a quality value or score of a changed modular system exceeds a threshold value.

According to the disclosure, a data carrier (computer-readable medium) is additionally specified with commands stored therein, which, if they are executed by one or more processors of a computing device, set up the computing device to carry out a method according to one or more exemplary embodiments.

In particular, the computing devices can configured to execute a method for optimizing a modular system for technical functional units of a process engineering plant, wherein the method comprises providing a modular system having a multiplicity of components for configuring technical functional units of a process engineering plant, wherein the modular system can be represented in a simulation environment in such a manner that each component from the multiplicity of components of the modular system can be represented on the basis of its physical properties as a virtual component with corresponding parameters in the simulation environment, varying parameters of the virtual components in the simulation environment, in order to determine at least one changed configuration of at least one technical functional unit using at least one of the virtual components with at least one varied parameter, and simulating the operation of the at least one technical functional unit of the process engineering plant with the at least one changed configuration, determining a set of virtual components from the virtual components with varied parameters based on results of the simulation, and adapting one or more components of the modular system on the basis of the determined set of virtual components.

According to a further aspect of the present disclosure, a computing device is defined, which is set up for optimizing a modular system for technical functional units of a process engineering plant, wherein the computing device comprises at least one processor, which is set up for providing a modular system having a multiplicity of components for configuring technical functional units of a process engineering plant, wherein the modular system can be represented in a simulation environment in such a manner that each component from the multiplicity of components of the modular system can be represented on the basis of its physical properties as a virtual component with corresponding parameters in the simulation environment, varying parameters of the virtual components in the simulation environment, in order to determine at least one changed configuration of at least one technical functional unit using at least one of the virtual components with at least one varied parameter, and simulating the operation of the at least one technical functional unit of the process engineering plant with the at least one changed configuration, determining a set of virtual components from the virtual components with varied parameters based on results of the simulation, and determining an adapted modular system with at least one adapted component, the physical properties of which are adapted on the basis of the determined set of virtual components.

In an exemplary embodiment, the computing device can be set up to execute any desired steps of the method according to the disclosure and of one or more embodiments of the method in any desired combination.

According to a further aspect of the present disclosure, a system is provided, which comprises at least one computing device according to an embodiment of the present disclosure. The system may be a distributed system of computing devices which can be connected via at least one network in order to communicate with one another over the network.

In an exemplary embodiment, the system may further comprise one or more databases, which store historical or current data for components and/or functional units and/or process engineering plants.

The computing device according to the disclosure and the system according to the disclosure, can, in exemplary embodiments, carry out any desired method steps according to embodiments of the method according to the disclosure in any desired combination and/or implement corresponding features. Furthermore, embodiments of the method according to the disclosure can be configured in such a manner that they provide features of embodiments of the computing devices according to the disclosure in any desired combination.

FIG. 1 shows a multiplicity of virtual components, which can be applied in embodiments of the present disclosure. In an exemplary embodiment, the virtual components 102a, 102b, . . . , 102n may be digital representations of real components of a modular system in a simulation environment, which can be used for designing and configuring technical functional units of a process engineering plant.

The technical functional unit may for example be a field device, a field device station or the like. The technical functional unit may for example be a control valve, which may have one or more of at least one adjustable valve with (or without) housing, at least one cover, at least one yoke, at least one control indicator, at least one control element, at least one inlet/outlet flange, at least one throttle element, at least one item of seal packing and/or at least one item of insulation and the like, in any desired combination. The control valve may further have at least one of a positioner, at least one booster, at least one pipework, at least one position measuring system, at least one bus system, at least one twin wire, at least one diagnostic unit and/or at least one wireless unit and the like, in any desired combination. Furthermore, the control valve may have at least one of at least one drive, at least one coupling, at least one vent, at least one membrane and/or at least one spring and the like, in any desired combination. The configuration of the control valve may be chosen in such a manner here that it has desired physical properties of the control valve according to one or more requirements.

The individual parts and units of the control valve or any desired other technical functional unit can here be configured from components of a modular system, as a result of which a wide palette of technical functional units can be provided on the basis of defined standard components from the modular system. The (standard) components of the modular system may be adaptable to the respective requirements of the technical functional unit on the basis of parameters in predetermined ranges. As a result, even higher variability in the configuration of technical functional units is achieved on the basis of the modular system. The modular system can be optimized in that the components of the modular system can preferably be investigated with regards to diverse requirements and influential factors in a simulation environment and as a result, the composition of the modular system can be adapted to current requirements.

Each of the virtual components 102a, 102b, . . . , 102n shown in FIG. 1 can be defined by one or more parameters 104. Each parameter 104 may define a variability of the design of the associated real component with regards to physical or functional properties of the real component. One parameter may for example be set to a particular value which determines a particular physical property of the real component and thus can also in its digital representation have a direct effect on the simulation of further virtual components.

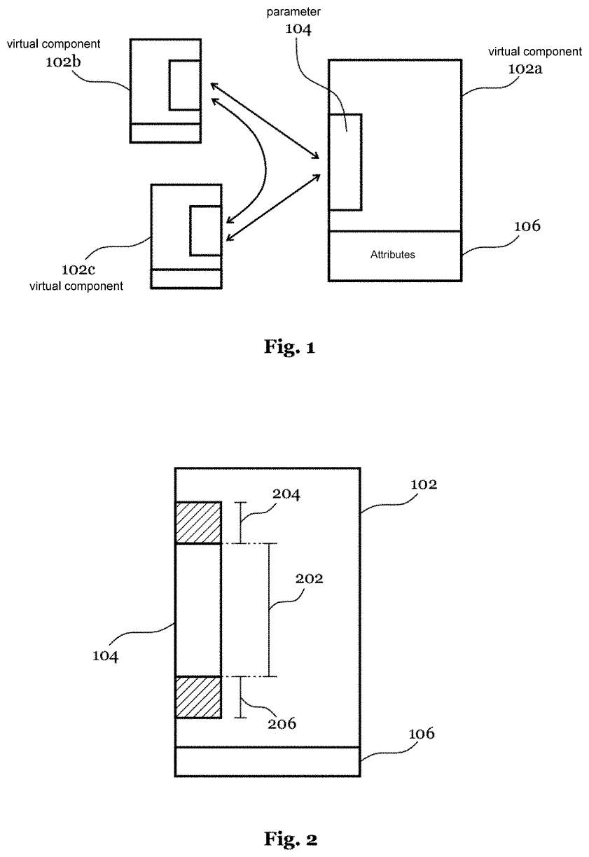

FIG. 2 shows a virtual component, for example the virtual component 102 in a detailed manner. Accordingly, the same or corresponding reference numbers are used as are also used in FIG. 1. As shown in FIG. 2, individual parameters 104 can for example be varied in a value range 202, which can be implemented directly by the corresponding real component (or a physical modification of the real component). The parameters 104 can be varied in a value range, for example an upper value range 204 and/or a lower value range 206, which does not have to be realizable by the physical component, but may be advantageous with regards to a design of a technical functional unit. As a result, changed and/or novel virtual components can be simulated in the simulation environment, which do not have an equivalent in the associated realization of the real component, but which can advantageously configure novel or changed technical functional units. Influential factors, which may comprise technical, functional or operational aspects, can be taken into account here. Advantageous virtual components for implementing technical functional units 102a, 102b, . . . , 102n may result from the simulation, as a result of which an optimum composition of the modular system can be determined.

Even if a lower and an upper value range 204, 206 are shown in FIG. 2, it should be understandable that value ranges in no way have to be limited one dimensionally and/or at the top and bottom. Rather, multi-dimensional value ranges are conceivable, which may extend in any desired dimensions, for example two-, three- or multi-dimensional value ranges.

The influential factors can be assigned to component level of each virtual component 102 by means of corresponding attributes 106. The attributes 106 may be assigned to individual influential factors.

A matrix may be assigned to each virtual component 102, which matrix may specify the individual influential variables and the relationships of the individual influential variables to one another. Thus, the matrix may have correlations of the influential variables with respect to the respective virtual component 102. Connected influential variables may for example be defined by fault notifications (complaints and the like) or diagnostic results of a technical functional unit that is implemented for real. The influential variables may further represent the requirement of individual components, manufacturing options and capacities and cost efficiency of the manufacturing, for example with regards to material requirements, energy consumption and the like.

A cluster of requirements can be created from the matrices assigned to the virtual components 102 and the respective relationships in an automated manner, which requirements can be classified downstream according to their degree of automation. It may for example be possible to realize fully automated requirements by means of a variation of the parameters 104.

One or more or the totality of the requirements can further be compared with available manufacturing capacities and loading plans, as a result of which further influential factors and weightings can be determined, for example on the basis of priorities. As a result, work orders for changed real components may be triggered. Such changed real components can in turn be represented in the simulation environment. In other words, the varied virtual components may remain in the simulation environment and reused for future simulations. Alternatively or additionally, on the bases of the changed real component, a digital representation of the changed real component can be created and introduced into the simulation environment. This digital representation may be able to represent the configuration of the changed real component more precisely.

Independently of the use of the real components in a technical functional unit, the available virtual components can be tested in the simulation environment with regards to updated influences and requirements and it is possible to search for a further optimization of the modular system. Here, a certain duration of the simulation, in which the determined virtual components must also prove themselves in the case of changing conditions, and the degree of improvement potential of the novel components is taken into account with regards to a changed configuration of the modular system, in order to bring about a real implementation of the modular system. A continuous automated improvement of the composition of the modular system and the corresponding components takes place in this manner.

The digital representations of the real components as digital twins in the form of virtual components 102 may have at least one data record with one or more of CAD, FEM, CFD or further simulation, design and modelling data, at least one measurement protocol, at least one tolerance, one or more surfaces, one or more materials, one or more surface treatments and the like, one or more interfaces, connections and the like, at least one standard, production costs, production times, quality, processing machines, CNC programs and the like, information on part compatibility inside technical functional units and/or information about wear and the like, in any desired combination. The individual data records and data fields can be mapped either directly or in combination onto the respective attributes 106 of the virtual components 102.

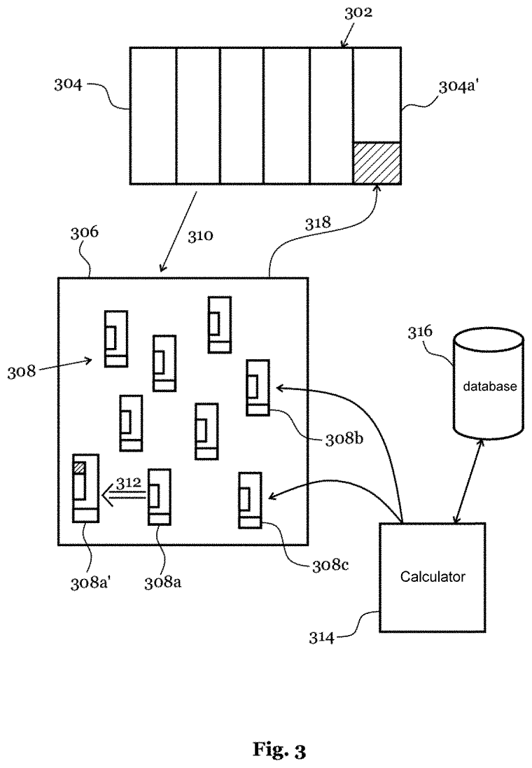

FIG. 3 is a schematic view of an environment for optimizing a modular system according to embodiments of the present disclosure.

The modular system 302 may have a multiplicity of real components 304. The real components 304 can be represented in a simulation environment 306 as virtual components 308, as is indicated by arrow 310, wherein each real component 304 can have a digital twin in the form of a corresponding virtual component 308. The digital representation may take place here analogously to the embodiments described in FIGS. 1 and 2, so that the virtual components 308 can also be the virtual components 102, 102a, 102b, . . . , 102n shown in FIGS. 1 and 2 with corresponding configuration and functionality. In particular, it may be possible to set and simulate each of the virtual components 308 by means of parameters and attributes, such as for example parameters 104 and attributes 106 from FIGS. 1 and 2. Here, settings of all virtual components 308 can even take place in the simulation environment 306, shown for example on the basis of a virtual component 308a, beyond a setting range and corresponding options of the associated real components 304, as is illustrated by arrow 312. As a result, the virtual component 308a can be set up as virtual component 308a′. The virtual component 308a′ set up in this manner can be simulated and evaluated in the simulation environment 306—even in association with the remaining virtual components 308.

The simulation and evaluation of all virtual components 308 in the simulation environment 306 can take place for example by means of a calculation module (calculator) 314. Here, the calculation module 314 can access a database 316, which can store different data records and provide an efficient retrieval of the data records, as is explained in the following in detail. In an exemplary embodiment, the calculation module 314 includes processing circuitry (e.g. a processor) that is configured to perform the functions of the calculation module 314. In an exemplary embodiment, the calculation module 314 is a computer or other computing device.

Should the simulation and evaluation of the virtual component 308a′ in the simulation environment 306 by the calculation module 314 result in a rating which does not satisfy a predefined threshold value, that is to say falls short of the same for example, then the virtual components 308a′ may remain in the simulation environment 306 in spite of that and/or be saved in the database 316 and/or be removed from the simulation environment 306 again.

However, should the simulation and evaluation of the virtual component 308a′ by the calculation module 314 lead to a rating which satisfies the predefined threshold value, that is to say is equal to or exceeds the same, then as indicated by the arrow 318, a changed real component 304a′ may be suggested on the basis of the changed virtual component 308a′ and provided in the modular system 302 as a standard component. These virtual components 308a′ can remain in the simulation environment 306 as a digital twin of the changed real component 304a′ and/or be stored in the database 316.

In addition to the virtual components, which represent digital twins of the real components of the modular system 302, the calculation module can also suggest novel virtual components 308b, 308c, which are inserted into the simulation environment 306 and can thereafter be simulated and evaluated.

The simulation and evaluation of virtual components in the simulation environment 306 can also be considered as an automated search for an optimum combination of the components of the real modular system 302. A comparison with real influential factors on the real modular system 302 can take place (constantly) in the automated search, as a result of which an optimum composition of the modular system 302 can be derived. Thus, novel components can be provided in the modular system 302, existing components 304 can be removed from the modular system 302 and/or for example components that have already been discontinued can be provided in the modular system 302 again. In this manner, the number of real and virtual components on which the real influential factors can have an effect and which are taken into account during the simulation and evaluation grows. The discovery of a best possible combination of components for the modular system 302 without or with only little manual reworking improves with increasing data of real and virtual components.

The modular system 302 can therefore be better adapted to the existing requirements and thus optimized. In an exemplary embodiment, the number of real components 304 in the modular system 302 can be taken into account for example as an influential variable, so that the number of real components 304 in an optimum design or configuration of the modular system 302 can be reduced. At the same time, the number of virtual components 308 in the simulation environment 306 can grow steadily.

The modular system 302 can be consulted for designing technical functional units, in that suggestions for individual functional units are generated automatically or semi-automatically. Here, data of the process engineering plant, which may for example be provided by customers, are considered as input variables. The input variables may comprise one or more of at least one flow coefficient, nominal size, physical size, temperature curve, pressure difference, process medium, characteristic, actuation times, fail-safe position, diagnostic function, SIL classification, explosion protection, environmental influences, communication interface, power interface, and/or peripheral devices, such as flow sensor, pressure sensors, and the like in any desired combination.

Relationships and interactions of the real components 304 of the modular system 302 can be calculated by means of mathematical support, for example on the basis of a product configurator or a comparable component, which can be executed in the calculation module 314. It should be understandable that the calculation module 314 is not limited to a certain product configurator or software and rather any desired component, module or computer program may be provided in the calculation module 314 for determining variants of a design of a technical functional unit. In an exemplary embodiment, possible, for example most obvious, variants of the desired functional units from a standard solution space of the modular system 302 may be suggested to a user of the product configurator (or a comparable component). The standard solution space of the modular system 302 results from combinations of the real components 304 here. To this end, starting from a first initial configuration, further variants of the desired functional units can be determined from the standard solution space of the modular system 302 with the aid of the calculation module 314. A degree of fulfilment can be assigned to the various variants in each case. The degree of fulfilment can be assigned individually to all requirements in a subsequent step, as a result of which it is possible to consider features and their influence on the degree of fulfilment.

Alternatively or additionally, at least one of costs for manufacturing of the functional unit configured in this manner, complexity of the configured functional unit, associated manufacturing times, a utilization and/or cost efficiency factor, can be assigned to all components of a suggested variant in any desired combination, which can be taken into account as further influential variables in the simulation and evaluation.

The cost-efficiency factor may here be composed of a need for the component from the past and a degree of current automation of the manufacturing. These data may be provided purely internally, so that a user does not have any access to them.

Variants or alternative components with comparable technical degrees of fulfilment can be compared and newly planned components based on novel virtual components 308b, 308c or existing virtual components, which hitherto had no equivalent in the modular system 302 however, can be evaluated. The data thus produced and all variants can be stored as historical data in the database 316. This evaluation leads to component suggestions, which are considered under economic aspects with corresponding comparison factors and degrees of fulfilment.

Further influential factors may comprise historical data from ongoing operation, such as failure rates, wear data, diagnostic data, which may have an influence at component level, and the like, in any desired combination, and may be assigned to one or more component. Even non-beneficial or non-functioning combinations of components may be represented at component level, so that correlations of components with one another at component level can be taken into account during the determination of variants of a design of technical functional units.

Customer data, which can be consulted during the determination of variants of a design of technical functional units can further define preferred components and/or a frequency of similar (earlier) orders. Identical parts can be taken into account during the configuration of variants, so that maintenance can be simplified.

Alternatively or additionally, customer data may show problems in the case of a customer's plants or defective customer data, which may be called upon during the determination of variants of a design of technical functional units, as a result of which faults and also component combinations which are non-beneficial for a customer can be avoided.

Furthermore, novel virtual components 308b, 308c and virtual components, which earlier corresponded to a real component 304 from the modular system 302, but do not currently correspond to real components 304 and therefore can be termed discontinued components, can be combined with customer requests and customer profiles in order to plan future customer-requirement-orientated novel or improved functional units.

Here, a preferred configuration or an associated technical corporate strategy may be specified in the customer data, such as excluding certain sectors and valve types or a preference of certain directions, such as e.g. cage valves. This information may be provided with a certain factor, which can be taken into account in the calculations, in order to prefer variants of the design of the technical functional unit on the basis of the desired configurations specified in the customer data.

All data, for example historical data, customer data, influential factors and the like, and current data can be stored in the database 316. The database 316 can be set up in such a manner that the corresponding data can be retrieved quickly by the calculation module 314 and used for simulation of the simulation environment 306.

In an exemplary embodiment, the calculation module 314 is configured to simulate and evaluate the virtual components 308 in the simulation environment 306 on one or more levels. These may have a configuration level, a diagnostic level, a cost-effectiveness level and a strategy level. Here, the configuration level may represent the individual configuration factors, for example real influential variables and the like on the real (or corresponding virtual) components. The diagnostic level may in particular take a real behaviour of existing configurations of technical functional units and further factors and influential variables, which relate to the diagnosis, into consideration. A cost-effectiveness level may in particular take into account costs and utilization of production of the technical functional unit according to suggested variants. Furthermore, the strategy level may take account of customer-orientated preferences, which may show technical aspects, such as for example customer-specific configurations of functional units, e.g. desired valve orientations and the like.

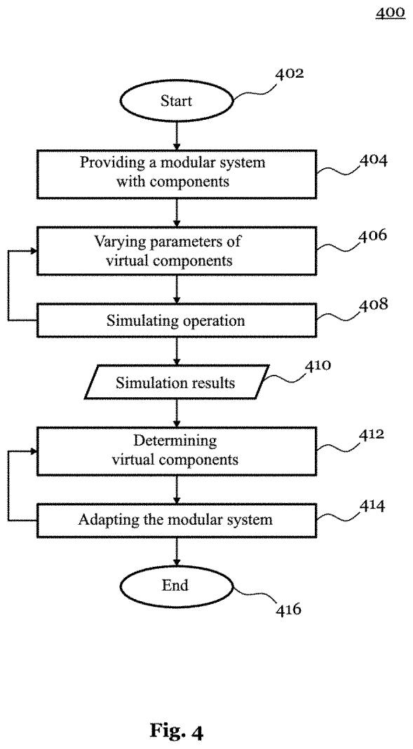

FIG. 4 shows a flow diagram of a method according to an embodiment of the present disclosure. The method may be a method 400 for optimizing a modular system for technical functional units of a process engineering plant.

The method may be executable on one or more computing devices. The computing devices may comprise a memory and at least one processor, which can read the corresponding commands from the memory and execute the same, so that the computing devices are set up to execute at least parts of the method 400. The method may be executable on a local computing device or on a multiplicity of computing devices, which may for example be arranged in a network or a cloud. At least parts of the method 400 can for example be executable on the computing module 314 from FIG. 3.

The method may begin with element 402 and subsequently provide in element 404 a modular system with a multiplicity of components for configuring technical functional units of a process engineering plant. The modular system can be represented in a simulation environment in such a manner that each component from the multiplicity of components of the modular system can be represented on the basis of its physical properties as a virtual component with corresponding parameters in the simulation environment.

The method 400 may continue with element 406, wherein parameters of the virtual components are varied in the simulation environment, in order to determine at least one changed configuration of at least one technical functional unit using at least one of the virtual components with at least one varied parameter. Here, the parameters of the virtual components can be varied by a calculation module, which can determine at least one variation of a parameter of a virtual component in the simulation environment for a technical functional unit. The variation may further take place on the basis of assigned attributes or a correlation of the attributes.

The attributes may be weighted. The attributes may describe interactions between the respective virtual components and one or more other virtual components, at least one technical functional unit and/or at least one process engineering plant. Alternatively or additionally, the attributes may be linked with at least one of historical diagnostic data of components, technical functional units and/or process engineering plants, real operating data of components, technical functional units and/or process engineering plants, and virtual operating data of simulated virtual components, technical functional units and/or process engineering plants. Furthermore, the attributes may alternatively or additionally be linked with at least one of manufacturing, assembly and/or commissioning information for at least one corresponding component, technical functional unit and/or process engineering plant. The calculation module can be trained with training data based on the attributes and linked information.

In element 408, the operation of the at least one technical functional unit of the process engineering plant can be simulated with the at least one changed configuration, which in each case may lead to simulation results 410 which can be stored for example in the database 316 from FIG. 3. The method 400 may continue iteratively with element 406, in that the parameters of virtual components can be varied further and subsequently simulated anew in element 408.

On the basis of simulation results 410, the method 400 can in element 412 determine a set of virtual components from the virtual components with varied parameters. The set of virtual components determined can be added to the simulation environment, as a result of which the simulation in element 408 can be influenced.

Both the variation of the parameters and the set of virtual components can be determined by a decision core of the calculation module, wherein the decision core is trained with data which can specify already configured modular systems for functional units of process engineering plants. The decision core can implement machine learning methods here. In an exemplary embodiment, the decision core may provide at least one statistical calculation module or at least one support vector machine and the like. Furthermore, one or more artificial neural networks or an analysis core based on a logistic regression, a distance classifier, a polynomial classifier or a cluster method may be provided. As a result, an optimum set of virtual components for the modular system can be determined on the basis of various influential variables, comprising one or more of historical data, current data, real influential factors, assigned attributes and their correlations and the like, and on the basis of existing and historical virtual components.

The set of virtual components determined can be used in element 414 in order to adapt one or more components of the real modular system and thus specify an optimized modular system which can be manufactured and used in the future.

The method may end in element 416.

It is understandable that the individual steps or parts of the method 400 can be executed sequentially or in parallel. Thus, the simulation can for example be carried out in elements 406 and 408, whilst at the same time the determination of the set of virtual components takes place in element 412 on the basis of earlier simulation results 410. Thus, in parallel to the simulation, the set of virtual components determined can be added to the simulation environment, wherein the simulation can refer directly back to the newly added virtual components.

The features of the individual embodiments of the present disclosure can be provided in any desired combination in further embodiments of the present disclosure and the present disclosure is not limited to a certain or isolated feature combination of embodiments.

To enable those skilled in the art to better understand the solution of the present disclosure, the technical solution in the embodiments of the present disclosure is described clearly and completely below in conjunction with the drawings in the embodiments of the present disclosure. Obviously, the embodiments described are only some, not all, of the embodiments of the present disclosure. All other embodiments obtained by those skilled in the art on the basis of the embodiments in the present disclosure without any creative effort should fall within the scope of protection of the present disclosure.

It should be noted that the terms “first”, “second”, etc. in the description, claims and abovementioned drawings of the present disclosure are used to distinguish between similar objects, but not necessarily used to describe a specific order or sequence. It should be understood that data used in this way can be interchanged as appropriate so that the embodiments of the present disclosure described here can be implemented in an order other than those shown or described here. In addition, the terms “comprise” and “have” and any variants thereof are intended to cover non-exclusive inclusion. For example, a process, method, system, product or equipment comprising a series of steps or modules or units is not necessarily limited to those steps or modules or units which are clearly listed, but may comprise other steps or modules or units which are not clearly listed or are intrinsic to such processes, methods, products or equipment.

References in the specification to “one embodiment,” “an embodiment,” “an exemplary embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The exemplary embodiments described herein are provided for illustrative purposes, and are not limiting. Other exemplary embodiments are possible, and modifications may be made to the exemplary embodiments. Therefore, the specification is not meant to limit the disclosure. Rather, the scope of the disclosure is defined only in accordance with the following claims and their equivalents.

Embodiments may be implemented in hardware (e.g., circuits), firmware, software, or any combination thereof. Embodiments may also be implemented as instructions stored on a machine-readable medium, which may be read and executed by one or more processors. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact results from computing devices, processors, controllers, or other devices executing the firmware, software, routines, instructions, etc. Further, any of the implementation variations may be carried out by a general-purpose computer.

For the purposes of this discussion, the term “processing circuitry” shall be understood to be circuit(s) or processor(s), or a combination thereof. A circuit includes an analog circuit, a digital circuit, data processing circuit, other structural electronic hardware, or a combination thereof. A processor includes a microprocessor, a digital signal processor (DSP), central processor (CPU), application-specific instruction set processor (ASIP), graphics and/or image processor, multi-core processor, or other hardware processor. The processor may be “hard-coded” with instructions to perform corresponding function(s) according to aspects described herein. Alternatively, the processor may access an internal and/or external memory to retrieve instructions stored in the memory, which when executed by the processor, perform the corresponding function(s) associated with the processor, and/or one or more functions and/or operations related to the operation of a component having the processor included therein. In one or more of the exemplary embodiments described herein, the memory is any well-known volatile and/or non-volatile memory, including, for example, read-only memory (ROM), random access memory (RAM), flash memory, a magnetic storage media, an optical disc, erasable programmable read only memory (EPROM), and programmable read only memory (PROM). The memory can be non-removable, removable, or a combination of both.

### LIST OF REFERENCE NUMBERS

102a, 102b, . . . , 102n Virtual components
104 Parameter
106 Attributes
202 Value range
204, 206 Upper value range, lower value range
302 Modular system
304 Real components
306 Simulation environment
308 Virtual components
308a, 308a′ Virtual component and changed virtual component
308b, 308c Novel virtual component
310 Digital representation
312 Setting up a virtual component
314 Calculation module (calculator)
316 Database (memory)
318 Providing a changed real component
400 Method
402, 416 Start and end of the method
404 Providing a modular system
406 Varying parameters
408 Simulating the operation of a technical functional unit
410 Simulation results
412 Determining a set of virtual components
414 Adapting components of the modular system

1. A method for optimizing a modular system for technical functional units of a process engineering plant, comprising:
providing a modular system having components for configuring technical functional units of the process engineering plant, wherein the modular system is representable in a simulation environment such that each of the components of the modular system are represented based on its physical properties as a virtual component with corresponding parameters in the simulation environment;
varying parameters of the virtual components in the simulation environment to determine at least one changed configuration of at least one technical functional unit using at least one of the virtual components with at least one varied parameter;
simulating operation of the at least one technical functional unit of the process engineering plant with the at least one changed configuration;
determining a set of virtual components, from the virtual components with varied parameters, based on results of the simulation; and
adapting one or more components of the modular system based on the determined set of virtual components.

2. The method according to claim 1, further comprising adding the determined set of virtual components to the simulation environment.

3. The method according to claim 1, wherein one or more attributes are assigned to each virtual component, the one or more attributes describing interactions between the respective virtual component and: one or more other virtual components, at least one technical functional unit, and/or at least one process engineering plant.

4. The method according to claim 3, wherein the one or more attributes are further linked with:
historical diagnostic data of components, technical functional units, and/or process engineering plants,
real operating data of components, technical functional units, and/or process engineering plants, and/or
virtual operating data of simulated virtual components, technical functional units and/or process engineering plants.

5. The method according to claim 3, wherein the one or more attributes are linked with at least one of manufacturing, assembly and/or commissioning information for at least one corresponding component, technical functional unit and/or process engineering plant.

6. The method according to claim 3, wherein the one or more attributes have at least one weighting.

7. The method according to claim 3, wherein the variation of the parameters takes place based on the one or more attributes and/or a correlation of the one or more attributes.

8. The method according to claim 1, wherein the variation of the parameters of the virtual components are varied using a calculator that is configured to determine at least one variation of a parameter of a virtual component in the simulation environment for a technical functional unit.

9. The method according to claim 8, further comprising training the calculator with training data based on attributes and linked information.

10. The method according to claim 1, wherein the determination of the set of virtual components comprises applying a search algorithm configured to discover an optimized combination of virtual components for configuring at least one technical functional unit of the process engineering plant.

11. The method according to claim 8, wherein the set of virtual components is determined using a decision core of the calculator, the decision core being trained with data specifying already configured modular systems for functional units of process engineering plants.

12. The method according to claim 8, wherein the calculator comprises:
a statistical decision core or a support vector machine, or
an artificial neural network or an analysis core based on a logistic regression, a distance classifier, a polynomial classifier or a cluster method.

13. The method according to claim 1, wherein the technical functional unit comprises at least one field device station, and wherein the process engineering plant is a chemical plant, a food-processing plant, or a power station.

14. The method according to claim 1, wherein the process engineering plant is representable in the simulation environment based on operation-specific plant features that indicate a type of a process medium, process fluid flow, number of field device stations, or plant environment.

15. The method according to claim 1, wherein the simulation is configured to influence at least one operating variable of the represented process engineering plant.

16. The method according to claim 1, wherein the varied parameters have at least one of a geometric parameter or a power parameter.

17. The method according to claim 1, further comprising a repeated variation of parameters to determine at least one further changed configuration of the at least one technical functional unit, and repeated simulation of the operation of the at least one technical functional unit of the process engineering plant with the at least one further changed configuration.

18. The method according to claim 1, wherein the simulation environment is provided, at least partially, in a distributed computing environment configured to simulate operation of one of the at least one technical functional units of the process engineering plant for one of the at least one changed configurations.

19. The method according to claim 1, further comprising providing the changed modular system for configuring technical functional units of the process engineering plant.

20. A non-transitory computer-readable storage medium with commands stored therein, which, when executed by one or more processors, instructs the processor to perform the method according to claim 1.

21. A computing device configured to optimize a modular system for technical functional units of a process engineering plant, the computing device comprising:
a data interface; and
at least one processor configured to:
represent a modular system having components for configuring technical functional units of a process engineering plant in a simulation environment such that each of the components are represented, based on its physical properties, as a virtual component with corresponding parameters in the simulation environment;
vary parameters of the virtual components in the simulation environment to determine at least one changed configuration of at least one technical functional unit using at least one of the virtual components with at least one varied parameter;
simulate the operation of the at least one technical functional unit of the process engineering plant with the at least one changed configuration;
determine a set of virtual components from the virtual components with varied parameters based on results of the simulation; and
determine an adapted modular system with at least one adapted component, physical properties of the at least one adapted component being adapted based on the determined set of virtual components.

22. A system having at least one computing device according to claim 21.

23. A system comprising:
at least one computing device according to claim 21; and
one or more databases that store historical or current data for components, functional units, and/or process engineering plants.
